(19) United States
(12) Patent Application Publication
(10) Pub. No.: US 2008/0054052 A1
(43) Pub. Date: Mar. 6, 2008

(54) METHOD OF MANUFACTURING SEMICONDUCTOR DEVICE

(76) Inventor: Hideyuki ARAKAWA, Tokyo (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 11/833,643

(22) Filed: Aug. 3, 2007

(30) Foreign Application Priority Data
Sep. 4, 2006 (JP) 2006-239252

(51) Int. Cl. B23K 1/20; B23K 31/02

(52) U.S. Cl. 228/244

(57) ABSTRACT

A manufacturing method of a semiconductor device which can cut a wire easily, can obtain a suitable-shaped bump electrode, and can pull out a wire easily from a capillary is obtained. The method includes the step of forming a bump electrode on a pad with the wire which passed to the capillary after the portion has eaten away in a capillary, a step at which a capillary is raised only 30 μm˜45 μm, a step which dwindles the wire which makes a capillary move only 35 μm˜55 μm to a horizontal direction after raising a capillary, a step which pulls out a wire from the capillary which raises a capillary after dwindling a wire, and the step which cuts a wire by pulling upward on both sides of a wire by a clamper after pulling out a wire from a capillary.

### CROSS-REFERENCE TO RELATED APPLICATION

The present application claims priority from Japanese patent application No. 2006-239252 filed on Sep. 4, 2006, the content of which is hereby incorporated by reference into this application.

### FIELD OF THE INVENTION

The present invention relates to a manufacturing method of a semiconductor device which forms a bump electrode on a pad with the wire which passed to the capillary, and especially relates to a manufacturing method of a semiconductor device which can make the cut of the wire from a bump electrode easy, and can obtain a suitable-shaped bump electrode.

### DESCRIPTION OF THE BACKGROUND ART

When doing bonding of the gold wire to Al pad on a chip directly, the load of a capillary concentrates and a crack enters into SiO2 interlayer insulation film under Al pad. For this reason, a bump electrode is used for wire bonding of a chip to chip (chip-to-chip). In a thin package, in order to make the height of a gold wire low, reverse bonding which used the bump electrode is performed. This bump electrode is formed on a pad with the wire which was passed to the capillary (for example, refer to Patent References 1-3).

[Patent Reference 1] Japanese Unexamined Patent Publication No. Hei 5-235002

[Patent Reference 2] U.S. Pat. No. 5,060,843 specification

[Patent Reference 3] Japanese Unexamined Patent Publication No. 2000-106381

### SUMMARY OF THE INVENTION

The gold wire was cut by crushing a gold wire by a capillary, thinning and conventionally, pulling on both sides of a gold wire by a clamper, after forming a bump electrode. However, since the bump electrode was soft, it became insufficient to crush of a gold wire and was not fully able to thin a gold wire. Hereby, since the strength of the gold wire became high, the distortion of the gold wire by the reaction at the time of cutting a gold wire, and the peeling from Al pad of a bump electrode had occurred. That is, there was a problem that a wire could not be cut easily.

There was a problem that the stitch bonding property of the wire in reverse bonding became unstable when the upper part of a bump electrode deforms into concave shape when crushing a gold wire by a capillary, or when a projection remains in a bump electrode after cutting a gold wire. And since a bump electrode constitutes a cushion agent in wire bonding and is used for reverse bonding, a certain amount of height is required for it. By the method of Patent Reference 1, by moving a capillary to a horizontal direction, a wire is dwindled and the cut of the wire from a bump electrode is made easy. However, after the portion has eaten away in a capillary, when forming a bump electrode, a part of bump electrodes will be shaved off. That is, there was a problem that a suitable-shaped bump electrode could not be obtained.

By the method of Patent Reference 2, when moving a capillary to a horizontal direction, the wire was cut. Therefore, the complicated step was required in order to pull out the wire for forming the following bump electrode from a capillary. That is, there was a problem that a wire could not be easily pulled out from a capillary. By the method of Patent Reference 3, there is disclosure about the step which dwindles the neck part of a wire by doing horizontal displacement after a capillary is raised to near the root of a gold wire when a gold ball deforms plastically in the case of bonding, in the state which entered the inside of the through hole of a capillary. In Patent Reference 3, although it is moving only the distance exceeding ⅔ of the diameter of a gold wire about the amount of horizontal displacement of a capillary, when the movement magnitude of a capillary is unsuitable, bump form may not be stabilized but it may become the form where a part of wires remained on the bump.

The present invention is made in order to solve the above problems. A purpose is to obtain the manufacturing method of the semiconductor device which can cut a wire easily, can obtain a suitable-shaped bump electrode, and can pull out a wire easily from a capillary.

A method of manufacturing a semiconductor device concerning this invention comprises the steps of forming a bump electrode on a pad with a wire which is passed to a capillary after a portion has eaten away in the capillary, raising the capillary only 30 μm˜45 μm, dwindling the wire making the capillary move only 35 μm˜55 μm to a horizontal direction after raising the capillary, raising the capillary and pulls out the wire from the capillary after dwindling the wire, and cutting the wire by pulling upward on both sides of the wire by a clamper after pulling out the wire from the capillary. The other features of the present invention are made clear to below.

By the present invention, a wire can be cut easily, a suitable-shaped bump electrode can be obtained, and a wire can be easily pulled out from a capillary.

### BRIEF DESCRIPTION OF THE DRAWINGS

FIG. 1 is a cross-sectional view showing an example of the semiconductor device manufactured by the manufacturing method concerning Embodiment 1 of the present invention;

FIG. 2 is a top view showing an example of the semiconductor device manufactured by the manufacturing method concerning Embodiment 1 of the present invention;

FIG. 3 is a side view for explaining the manufacturing method of the semiconductor device concerning Embodiment 1 of the present invention;

FIG. 4 is the plan view which observed the state of FIG. 3 from the upper part;

FIG. 5 is a side view for explaining the manufacturing method of the semiconductor device concerning Embodiment 1 of the present invention;

FIG. 6 is the plan view which observed the state of FIG. 5 from the upper part;

FIGS. 7 and 8 are side views for explaining the manufacturing method of the semiconductor device concerning Embodiment 1 of the present invention;

FIG. 9 is the plan view which observed the state of FIG. 8 from the upper part;

FIG. 10 is a side view for explaining the manufacturing method of the semiconductor device concerning Embodiment 1 of the present invention;

FIG. 11 is the plan view which observed the state of FIG. 10 from the upper part;

FIG. 12 is a drawing showing the experimental result which examined the form of the bump electrode according to the ascending amount and the amount of transverse movements of a capillary;

FIGS. 13 to 16 are side views for explaining the manufacturing method of the semiconductor device concerning Embodiment 1 of the present invention; and

FIGS. 17 to 19 are side views for explaining the manufacturing method of the semiconductor device concerning Embodiment 2 of the present invention.

### DETAILED DESCRIPTION OF THE PREFERRED EMBODIMENTS

### Embodiment 1

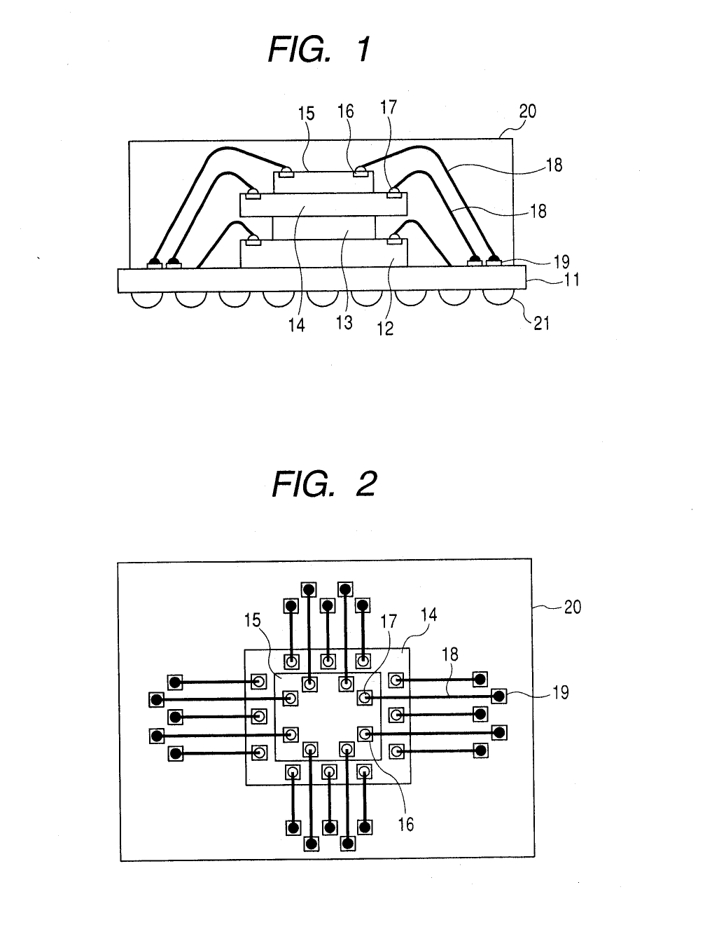

FIG. 1 is a cross-sectional view showing an example of the semiconductor device manufactured by the manufacturing method concerning Embodiment 1 of the present invention, and FIG. 2 is the top view. On glass epoxy wiring substrate 11, chip 12, spacer chip 13, chip 14, and chip 15 are loaded. Bump electrode 17 is formed on aluminum pad 16 of chips 12, 14, and 15. And ball bonding of the gold wire 18 is done to pad 19, and stitch bonding is done on bump electrode 17. The whole is sealed with sealing resin 20 and solder ball 21 is formed in the bottom of glass epoxy wiring substrate 11.

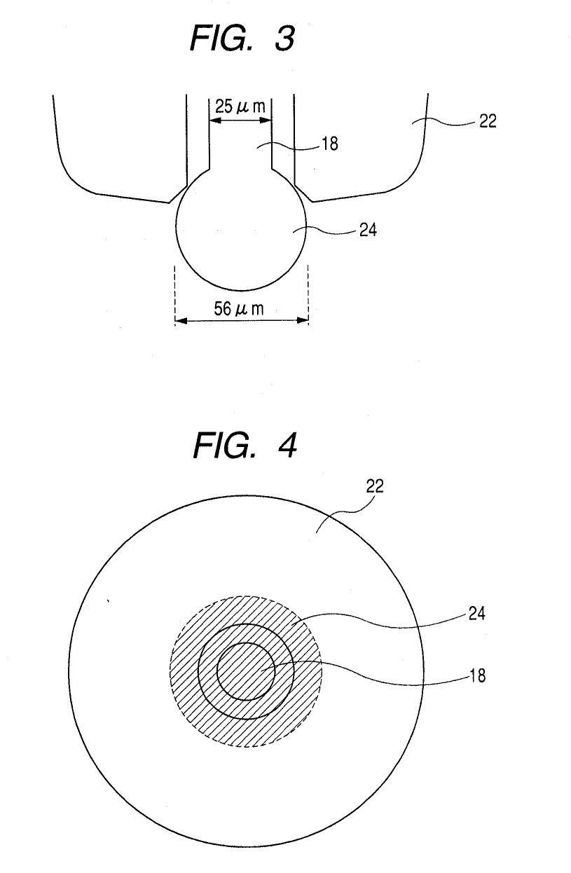

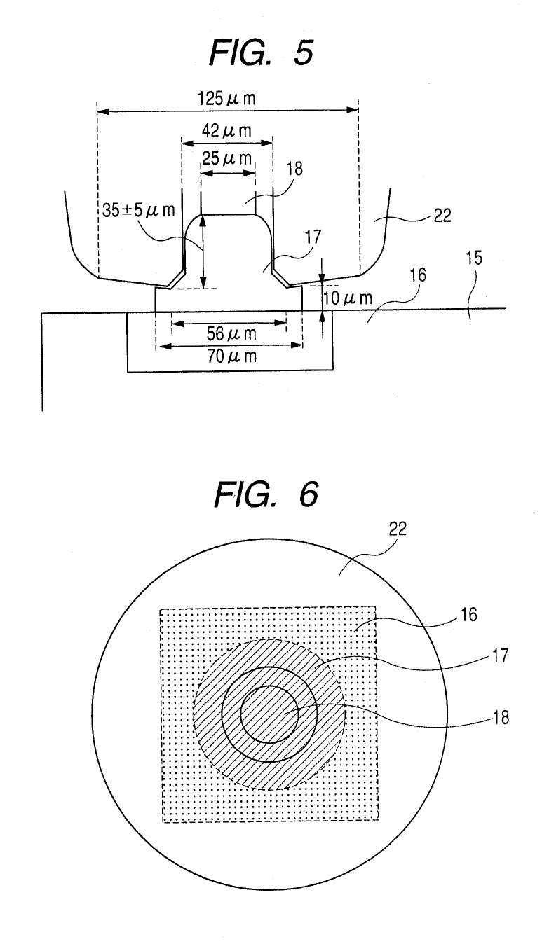

Hereafter, the manufacturing method of the semiconductor device concerning Embodiment 1 of the present invention is explained. First, as shown in FIG. 3, gold ball 24 with a larger diameter than gold wire 18 is formed by melting the tip of gold wire 18 which passed to capillary 22 by electric discharge from a torch (un-illustrating). When this state is seen from the upper part, it will become like FIG. 4. Here, the diameter of gold wire 18 is 25 μm, and the diameter of gold ball 24 is 56 μm. The form of the capillary in FIG. 4 is drawn as a part for the projection part of the tip surface of a capillary. That is, an inside circle shows the position of the inner wall of the through hole of a capillary, and the diameter is 42 μm in this embodiment. Although an outside circle points out a boundary part with the side surface of a capillary, the boundary of the tip surface of a capillary and a side surface is formed by the curved surface as shown in FIG. 3 or FIG. 5. Then, to chip 15 main surface, the surface which makes the angle of 45 or less degrees is a tip surface of a capillary, and defines it as the surface which makes the angle of 45 degrees or more being the side surface or through hole inner wall of a capillary. In this embodiment, the diameter of the tip surface of a capillary is 125 μm.

Next, as shown in FIG. 5, the interface of aluminum pad 16 is joined to gold ball 24 by pushing and pressing gold ball 24 on aluminum pad 16 of chip 15, and applying 30 g of loads, heat, an ultrasonic wave, etc. by capillary 22. When this state is seen from the upper part, it will become like FIG. 6. On aluminum pad 16, this forms bump electrode 17, after the portion has eaten away in capillary 22. Here, the height of the portion which ate away in capillary 22 of bump electrode 17 is 35±5 μm, and the width is the same 42 μm as the inside diameter of a capillary through hole. The height of the portion out of capillary 22 of bump electrode 17 is 10 μm, and the width is 70 μm. And the width of the taper part at capillary 22 tip is 56 μm.

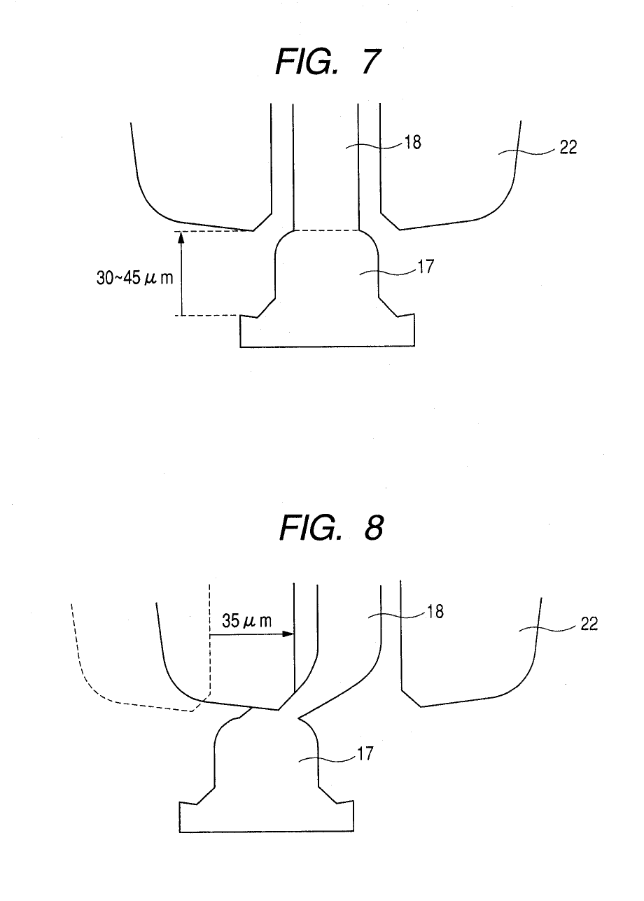

Next, as shown in FIG. 7, capillary 22 is raised only by 30 μm˜45 μm. Hereby, the tip of capillary 22 comes to the height of −5 μm˜10 μm to the boundary line of bump electrode 17 and gold wire 18.

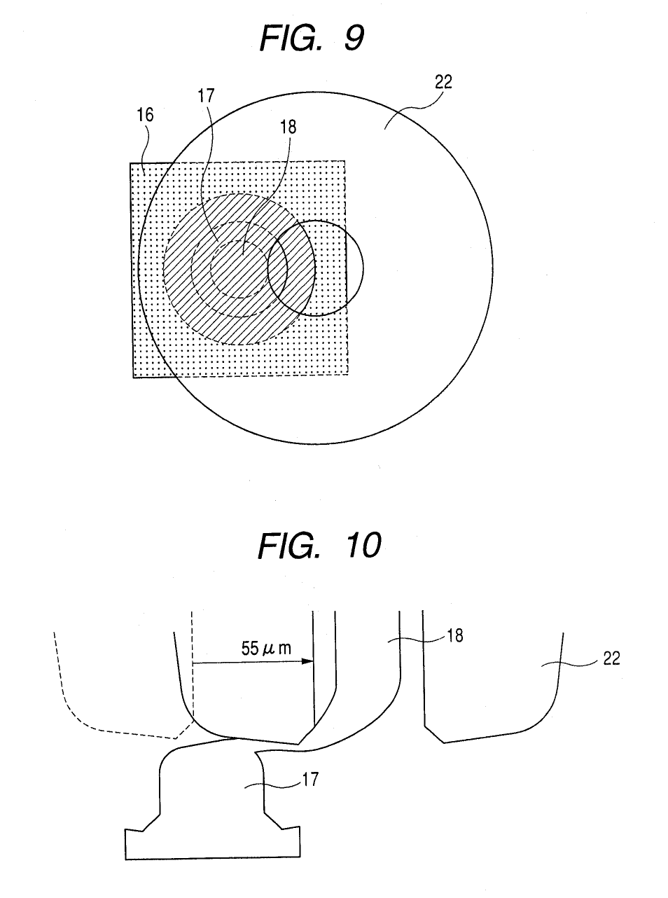

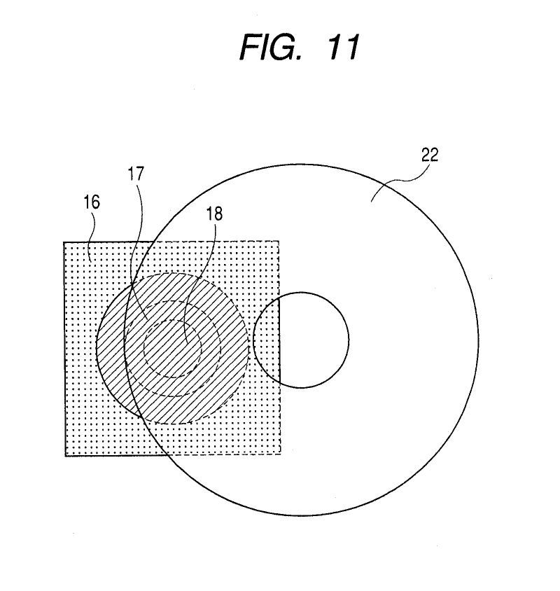

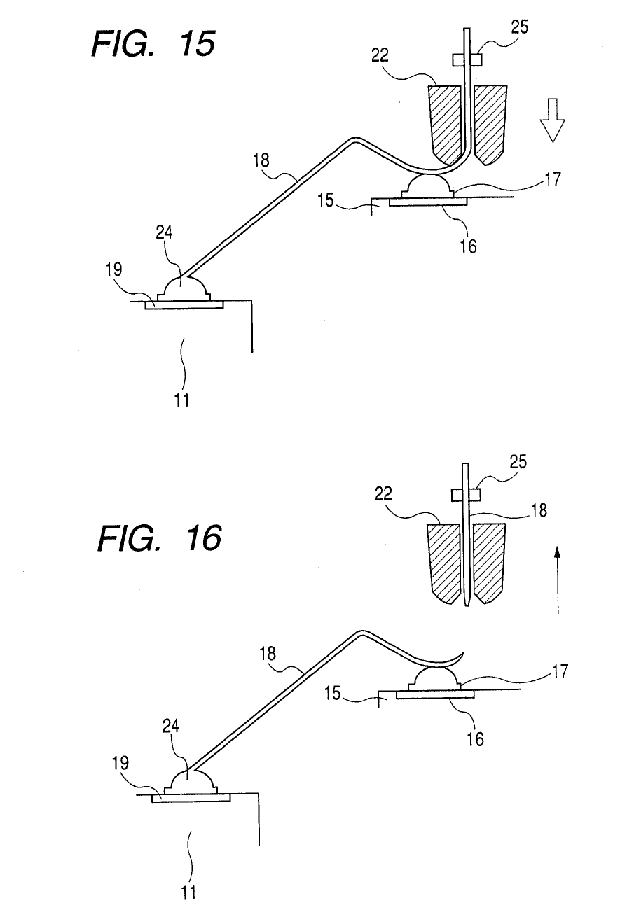

Next, capillary 22 is moved 35 μm˜55 μm, for example, 45 μm, to a horizontal direction, and gold wire 18 is dwindled. Here, when capillary 22 is moved only 35 μm to a horizontal direction, as shown in FIG. 8, the inner wall of capillary 22 will come to the position of the outer wall of gold wire 18 which is in the opposite side with the inner wall of capillary 22. When this state is seen from the upper part, it will become like FIG. 9. In the state of FIG. 9, the junction portions of gold wire 18 and bump electrode 17 are located directly under a capillary 22 tip surface. Thus, capillary 22 is moved so that the whole surface of the junction portion of gold wire 18 and bump electrode 17 may be located directly under a capillary 22 tip surface on a plan view. Hereby, a part of gold wires 18 can be made thin enough, and the form of bump electrode 17 after gold wire 18 cutting can be stabilized. On the other hand, when capillary 22 is moved only 55 μm to a horizontal direction, as shown in FIG. 10, a horizontal distance of the inner wall of capillary 22 and the junction portion of gold wire 18 and bump electrode 17 will become large. Here, where capillary 22 is moved to 55 μm horizontal direction, the horizontal distance of the inner wall of capillary 22 and the junction portion of gold wire 18 and bump electrode 17 is smaller than 25 μm which is a diameter of gold wire 18. When this state is seen from the upper part, it will become like FIG. 15. By moving capillary 22 to a horizontal direction within the limits of these positions, gold wire 18 can be dwindled to the degree which does not cut. Namely, where capillary 22 is moved to a horizontal direction, when horizontal distance of the inner wall of capillary 22 with the junction portion of gold wire 18 and bump electrode 17 becomes larger than the diameter of gold wire 18, the case where gold wire 18 cuts will occur and a possibility of having a bad influence on a subsequent wire-bonding step will become high.

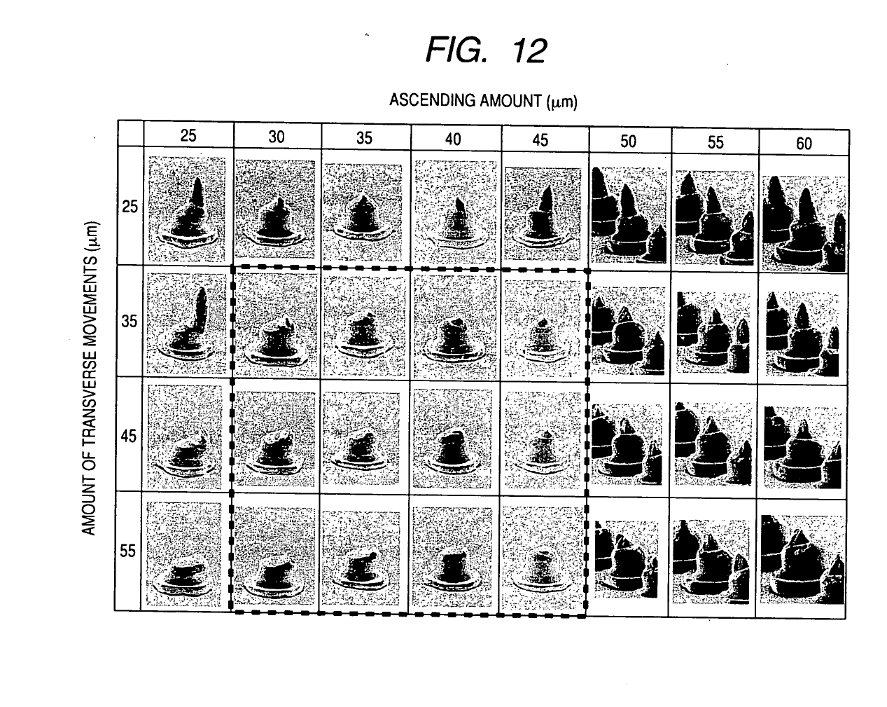

FIG. 12 is a drawing showing the experimental result which examined the form of the bump electrode according to the ascending amount and the amount of transverse movements of a capillary. This result shows that a suitable-shaped bump electrode can be obtained when the ascending amount of a capillary is 30 μm˜45 μm and the amount of transverse movements is 35 μm˜55 μm. That is, a certain amount of height can be secured and a suitable-shaped bump electrode can be obtained without a projection's remaining in a bump electrode, even when forming a bump electrode, after the portion has eaten away in a capillary.

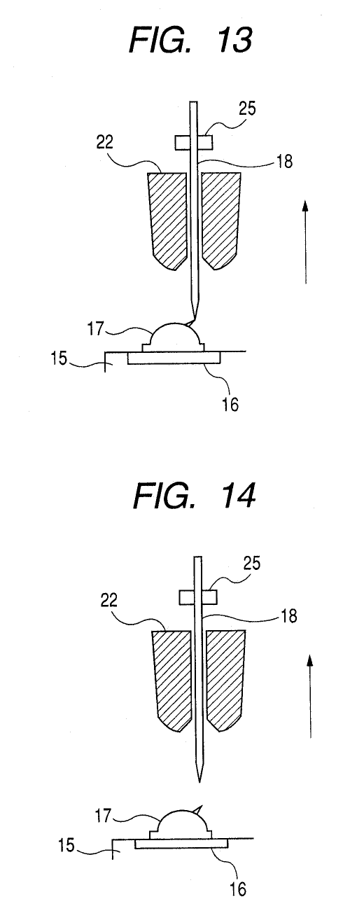

Next, as shown in FIG. 13, gold wire 18 is pulled out from capillary 22 by raising capillary 22, where bump electrode 17 is connected with gold wire 18. Hereby, gold wire 18 for forming the following bump electrode can be easily pulled out from capillary 22.

Next, as shown in FIG. 14, gold wire 18 is cut on bump electrode 17 by pulling upward on both sides of gold wire 18 above capillary 22 by clamper 25. Here, since gold wire 18 is dwindled by a rise and transverse movement of capillary 22 as mentioned above, gold wire 18 can be cut easily.

Next, gold ball 24 is formed at the tip of gold wire 18 discharged from capillary 22 like FIG. 3. As shown in FIG. 15, ball bonding of the gold ball 24 at the tip of gold wire 18 is done to pad 19 of glass epoxy wiring substrate 11 using capillary 22. Then, gold wire 18 prolonged from gold ball 24 is discharged from capillary 22, and it lengthens on bump electrode 17. Stitch bonding of a part of gold wires 18 prolonged from gold ball 24 is done on bump electrode 17, pushing and pressing gold wire 18 for 10 ms to bump electrode 17 by capillary 22, and applying supersonic vibration.

Next, as shown in FIG. 16, gold wire 18 is cut by pulling upward on both sides of gold wire 18 by clamper 25. Thus, pad 19 of glass epoxy wiring substrate 11 is electrically connected with bump electrode 17 with gold wire 18 discharged from capillary 22. Then, the semiconductor device shown in FIG. 1 is manufactured through the usual manufacturing process.

### Embodiment 2

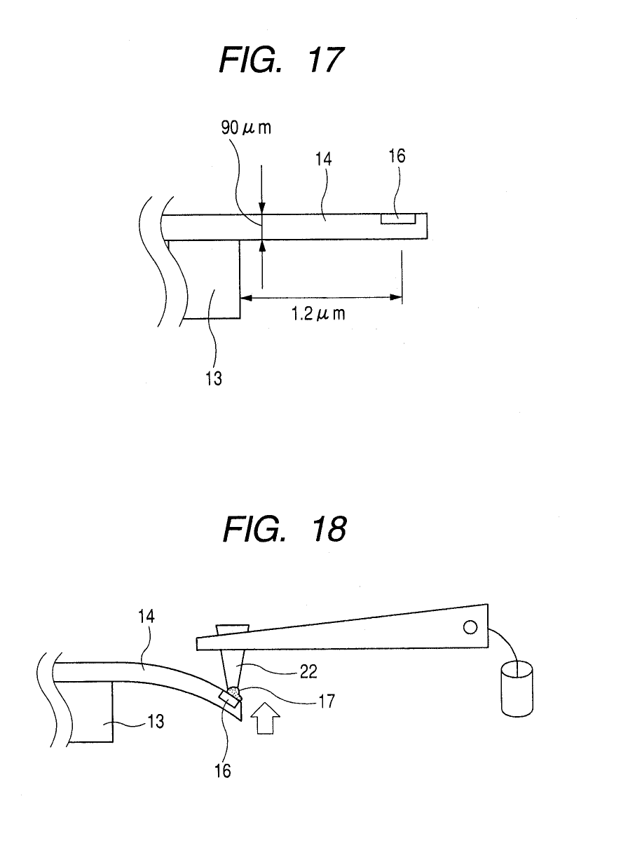

Hereafter, the manufacturing method of the semiconductor device concerning Embodiment 2 of the present invention is explained. In this embodiment, as shown in FIG. 17, aluminum pad 16 is formed in a part for the over hang to spacer chip 13 of chip 14. In this case, as shown in FIG. 18, chip 14 bends below according to 30 g of loads of capillary 22 to aluminum pad 16 at the time of formation of bump electrode 17.

Then, as shown in FIG. 7, after forming bump electrode 17 on aluminum pad 16 and before raising capillary 22, it shall be lower than the time of formation of bump electrode 17, for example, the load of capillary 22 to aluminum pad 16 shall be 5 g or less. And after the tip of capillary 22 has touched bump electrode 17 as it is, it maintains 5 ms or more. As shown in FIG. 17 here, when the length for an over hang of chip 14 is 1.2 mm and the thickness of chip 14 is 90 μm, the length for an over hang of chip 14 is 10 or more times of the thickness of chip 14. In this case, the above-mentioned state is maintained 16 ms or more preferably at least 10 ms or more.

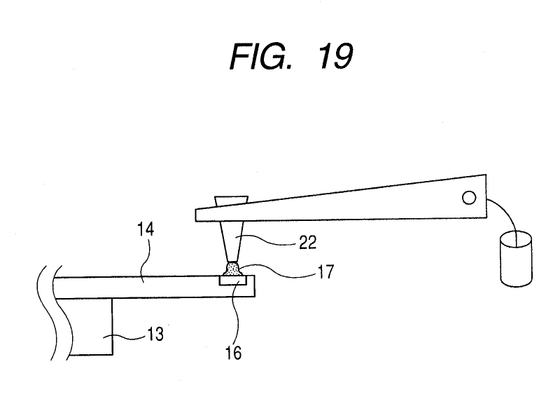

Chip 14 which had bent below goes up according to the above-mentioned step, and as shown in FIG. 19, bending of chip 14 is canceled. After that, as shown in FIG. 7, capillary 22 is raised only 30 μm˜45 μm. Other steps are the same as that of Embodiment 1. Hereby, like Embodiment 1, even when forming a bump electrode in a part for the over hang of a chip, a certain amount of height can be secured and a suitable-shaped bump electrode can be obtained without a projection's remaining in a bump electrode.

What is claimed is:

1. A method of manufacturing a semiconductor device, comprising the steps of:
forming a bump electrode on a pad with a wire which is passed to a capillary after a portion has eaten away in the capillary;
raising the capillary only 30 μm˜45 μm;
dwindling the wire making the capillary move only 35 μm˜55 μm to a horizontal direction after raising the capillary;
raising the capillary and pulls out the wire from the capillary after dwindling the wire; and
cutting the wire by pulling upward on both sides of the wire by a clamper after pulling out the wire from the capillary.

2. A method of manufacturing a semiconductor device, comprising the steps of:
forming a bump electrode on a pad with a wire which is passed to a capillary after a portion has eaten away in the capillary;
raising the capillary so that a tip of the capillary comes to a height of −5 μm˜10 μm to a boundary line of the bump electrode and the wire;
moving the capillary to a horizontal direction so that an inner wall of the capillary comes between a position of an outer wall of the wire which is in an opposite side with an inner wall of the capillary and a position to which only a diameter of the wire went further from a position of an outer wall of the wire which is in an opposite side with an inner wall of the capillary and dwindling the wire after raising the capillary;
raising the capillary and pulling out the wire from the capillary after dwindling the wire; and
cutting the wire by pulling upward on both sides of the wire by a clamper after pulling out the wire.

3. A method of manufacturing a semiconductor device according to claim 1, wherein
the pad is formed in a part for an over hang of a chip; and
the method of manufacturing a semiconductor device further comprises a step of:
maintaining 5 or more ms after a tip of the capillary has touched the bump electrode making load of the capillary to the pad lower than a time of formation of the bump electrode after forming the bump electrode on the pad and before raising the capillary.

4. A method of manufacturing a semiconductor device according to claim 1, wherein
the pad is formed in a part for an over hang of a chip;
a length for an over hang of the chip is 10 or more times of a thickness of the chip; and
the method of manufacturing a semiconductor device further comprises a step of:
maintaining 10 or more ms after a tip of the capillary has touched the bump electrode making load of the capillary to the pad lower than a time of formation of the bump electrode after forming the bump electrode on the pad and before raising the capillary.

5. A method of manufacturing a semiconductor device according to claim 1, wherein
the pad is formed in a part for an over hang of a chip;
a length for an over hang of the chip is 10 or more times of a thickness of the chip; and
the method of manufacturing a semiconductor device further comprises a step of:
maintaining 16 or more ms after a tip of the capillary has touched the bump electrode making load of the capillary to the pad lower than a time of formation of the bump electrode after forming the bump electrode on the pad and before raising the capillary.
